(19) United States
(12) Patent Application Publication
(10) Pub. No.: US 2012/0276947 A1
(43) Pub. Date: Nov. 1, 2012

(54) Symmetrical communicator device that dynamically changes the function of the hardware as orientation of the device changes.

(76) Inventor: Daniel Adam Smith, Orange Park, FL (US)

(21) Appl. No.: 13/094,857

(22) Filed: Apr. 27, 2011

(51) Int. Cl. H04W 88/08

(52) U.S. Cl. 455/550.1

(57) ABSTRACT

A symmetrical communicator device that dynamically changes the function of the hardware as orientation changes solves the problem in prior art where users are required to hold the device in a specific orientation to perform certain tasks (e.g. make or receive phone calls). The symmetrical device will have identical hardware buttons, speakers, and microphones on each end of the device. Using a built in accelerometer to determine orientation, the device will dynamically change the function of, disable, or enable the hardware buttons, speakers, and microphones to suit the orientation of the phone. This invention will allow the communicator device to be used in a consistent manner regardless of the orientation of the phone, due to the symmetrical duplication of hardware buttons, speakers, and microphones at each end of the device.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM, LISTING COMPACT DISC APPENDIX

Not applicable

### BACKGROUND OF THE INVENTION

Prior art in communicator devices has incorporated the reconfiguration of buttons as orientation changes; however, these changes are not symmetrical, so users must adapt to the layout of the buttons. Additionally, hardware on prior art in communicator devices requires the device to he held and used in a specific orientation/manner. For example, prior art in communicator devices require communicator devices to be held in a specific orientation, due to the physical location of a hardware speaker and microphone.

### BRIEF SUMMARY OF THE INVENTION

The invention of symmetrical communicator device that dynamically changes the function of the hardware as orientation changes solves the problem in prior art where users are required to hold the device in a specific orientation to perform certain tasks (e.g. make or receive phone calls). The symmetrical device will have identical hardware buttons, speakers, and microphones on each end of the device. Using a built in accelerometer to determine orientation, the device will dynamically change the function of, disable, or enable the hardware buttons, speakers, and microphones to suit the orientation of the phone. This invention will allow the communicator device to be used in a consistent manner regardless of the orientation of the phone, due to the symmetrical duplication of hardware buttons, speakers, and microphones at each end of the device.

### BRIEF DESCRIPTION OF THE DRAWINGS

FIG. 1 shows an embodiment of the symmetrical communicator device.

FIG. 2 shows an embodiment of the symmetrical communicator device oriented in the opposite manner as FIG. 1.

FIG. 3 demonstrates how the symmetrical device dynamically swaps, enables, or disables hardware functions based upon orientation.

### DETAILED DESCRIPTION OF THE INVENTION

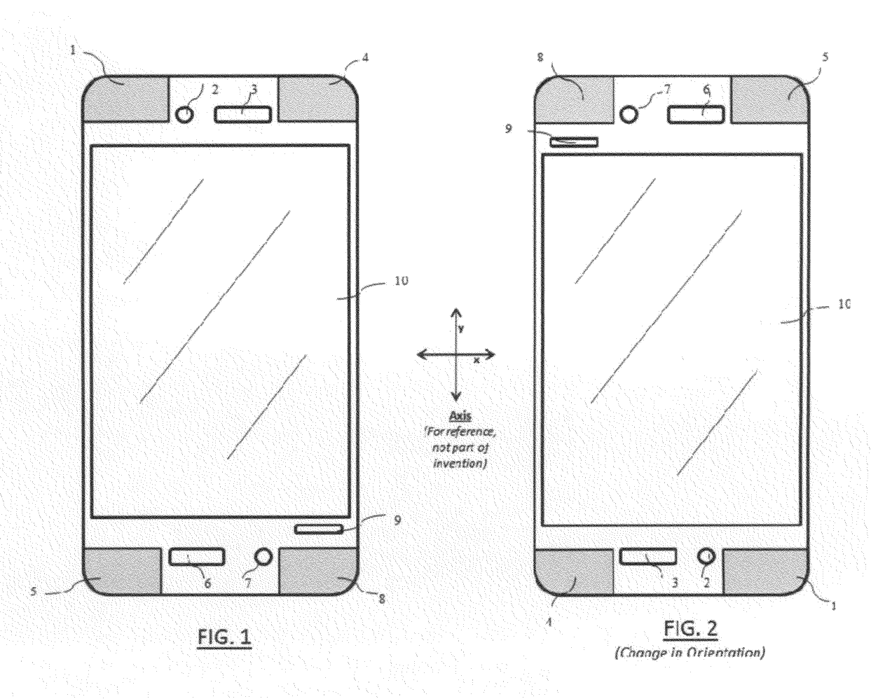

FIG. 1. Shows an embodiment of the symmetrical communicator device.

Conventional mobile communicator devices have distinct buttons and hardware in certain locations on the device. When held properly, conventional devices have an earpiece at the top, microphone at the bottom, and buttons in various locations. In order to use the device properly, the device must be held in a certain orientation. By combining orientation determining technology (accelerometer) with symmetrical hardware, orientation no longer needs to be considered when using the device.

In the embodiment; buttons, earpieces, and microphones appear at both ends of the device, and are thus symmetrical.

Using an accelerometer to determine orientation shown as position 9, the mobile device can dynamically swap functions, disable, or enable hardware shown in positions 1-8.

In FIG. 1, the device is oriented with hardware positions 1-4 at the top of the unit. In this embodiment, the earpiece/speaker shown as position 3 and microphone shown as position 7 would be enabled. Alternatively, the earpiece/speaker shown as position 6 and the microphone shown as position 2 would be disabled. Additionally, hardware buttons shown as position 1 and 4 would be configured as the desired function of the top buttons, while buttons shown as position 5 and 8 would be configured to the desired function of bottom buttons. The display shown in position 10 would also adjust to the corresponding orientation.

In FIG. 2, the embodiment shows the device oriented in the opposite manner as FIG. 1. Using the accelerometer shown as position 9, they mobile device will dynamically change the function of the hardware shown in positions 1-8. In contrast to FIG. 1, FIG. 2 enables the earpiece/speaker shown as position 6 and the microphone shown as position 2. Alternatively, the earpiece/speaker shown as position 3 and the microphone shown as position 7 would be disabled. In FIG. 2, hardware shown as positions 1 and 4 would be assigned the desired function for bottom buttons, while hardware buttons shown as positions 5 and 8 would be assigned the desired functions for top buttons. In FIG. 2, position 8 would carry out the functions of position 1 in the previous orientation shown in FIG. 1, and so on.

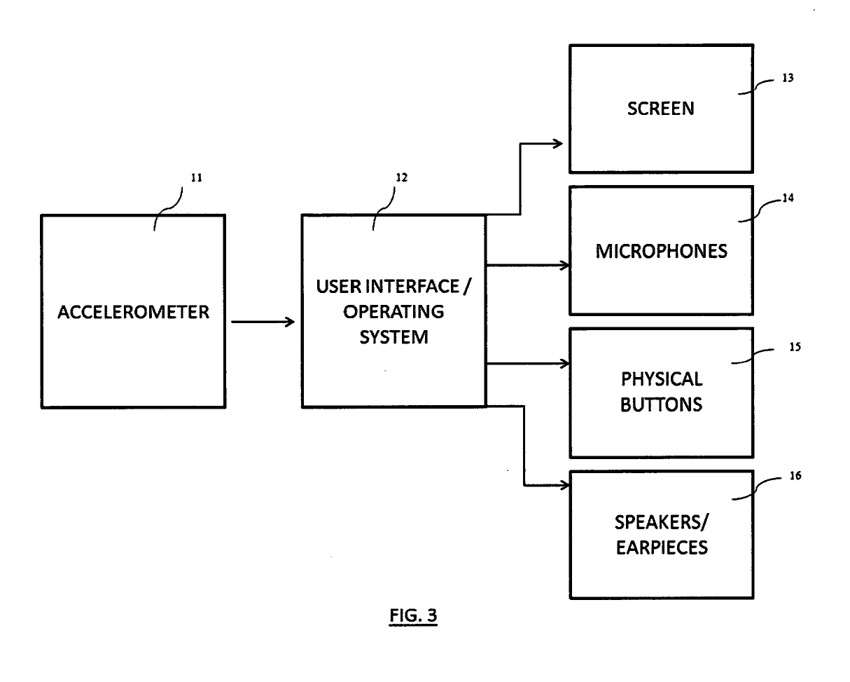

In FIG. 3, the illustration shows the function of the accelerometer shown as position 11 to communicate with the user interface/operating system shown as position 12. The user interface/operating system shown as position 12 then makes changes to the hardware screen, microphones, physical buttons, and speakers/earpieces shown in positions 13-16.

1. What I claim as my invention is a symmetrical communicator device that dynamically changes the function of hardware to adapt to its orientation. Symmetry is accomplished by duplicating hardware on each end of the device.

2. A device as in claim 1, wherein identical symmetrical hardware at each end of the device will be alternately disabled and enabled based upon orientation of the device.

3. A device as in claim 1, wherein the function of identical symmetrical hardware at each end of the device will swap functionality based upon the orientation of the device
